(19) United States
(12) Patent Application Publication
(10) Pub. No.: US 2002/0079141 A1
(43) Pub. Date: Jun. 27, 2002

(54) Media weight sensor employing acoustic transmission

(76) Inventor: Phillip R. Luque, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/745,570

(22) Filed: Dec. 18, 2000

(51) Int. Cl. G01G 9/00

(52) U.S. Cl. 177/1

(57) ABSTRACT

This invention relates to a media weight sensor of the type that includes transducers located both above and below the media, whose weight is to be determined. One transducer is driven with an AC signal of a given frequency. The acoustic energy passing through the media reaches the other transducer, thereby generating an AC voltage signal. The level of the signal is proportional to the amount of acoustic energy reaching this transducer. The heavier the media, the more energy is blocked or absorbed and the lower is the level of the signal received by the second transducer.

### FIELD OF THE INVENTION

This invention relates to a media weight sensor of the type that includes transducers located both above and below the media, whose weight is to be determined. One transducer is driven with an AC signal of a given frequency. The acoustic energy passing through the media reaches the other transducer, thereby generating an AC voltage signal. The level of the signal is proportional to the amount of acoustic energy reaching this transducer. The heavier the media, the more energy is blocked or absorbed and the lower is the level of the signal received by the second transducer.

### DESCRIPTION OF THE RELATED ART

It is known, in paperweight sensors, to employ optical sensors. Exemplary of such prior art is U.S. Pat. No. 5,138,178 ('178) to L. F. Wong et. al., entitled “Photoelectric Paper Basis Weight Sensor” and U.S. Pat. No. 5,127,643 ('643) to A. T. DeSanctis et. al., entitled “Automatic Copy Sheet Selection Device.” While the '178 and '643 references employ optical sensors, these sensors are used to measure thickness or weight of the paper. These measurements are accomplished by measuring the amount of light that passes through the paper. However, if the paper is coated, this coating can adversely affect how much light passes through the paper. Consequently, an accurate measurement may not be obtained.

It is also known, in paperweight sensors, to measure the stiffness of the paper in order to determine the weight of the paper. Exemplary of such prior art is commonly assigned U.S. Pat. No. 5,962,861 ('861) to P.

Fowler, entitled “Sheet Media Weight Detector and Method” and commonly assigned U.S. Pat. No. 6,028,318 ('318) to W. L. Cornelius, entitled “Print Media Weight Detection System.” While the '861 and '318 references measure the stiffness of the paper in order to ascertain the weight of the paper, these do not employ an acoustic resonator. Instead, these references measure the deflection of the paper that is related to the stiffness and, thereby the weight of the paper.

Finally, it is known, in paperweight sensors, to measure paper thickness. Exemplary of such prior art is U.S. Pat. No. 5,806,992 ('992) to Y. Ju, entitled “Sheet Thickness Sensing Technique and Recording Head Automatic Adjusting Technique of Ink Jet Recording Apparatus Using Same.” While the '992 reference measures sheet thickness, it does so by measuring the amount of arm rotation, which can result in a complex and fragile assembly. While the apparatus of the '992 reference may be able to accurately measure the thickness of the sheet of paper, in order to determine the weight of the paper, assumptions must be made as to the makeup of the sheet of paper. For example, it must be assumed that each sheet of paper has the same density. However, it is well known that the density of sheets of paper in the same stack of paper can vary by as much as a factor of two. Consequently, a weight determination cannot be accurately made.

It is apparent from the above that there exists a need in the art for a media weight sensor system which is lightweight through simplicity of parts and uniqueness of structure, and which at least equals the media weight sensing characteristics of the known media weight sensors, but which at the same time employs an acoustic resonator. It is a purpose of this invention to fulfill this and other needs in the art in a manner more apparent to the skilled artisan once given the following disclosure.

### SUMMARY OF THE INVENTION

Generally speaking, this invention fulfills these needs by providing a media weight sensing apparatus, comprising a media, whose weight is to be determined, wherein the media includes a first and a second side, an acoustic driving transducer means located substantially adjacent to the first side of the media, and an acoustic sensing transducer means located substantially across from the acoustic driving transducer means and substantially adjacent to the second side of the media.

In certain preferred embodiments, the acoustic driving transducer means includes a housing, a disk, and a drive circuit. Also, the acoustic sensing transducer means includes a housing, a disk, and a sensing circuit. Finally, the media weight sensing apparatus may include a media traversing means.

In another preferred embodiment, the apparatus measures a media property that is a combination of both the media thickness and density. As a result, the measurement may more accurately reflect the media weight by measuring the change of signal level of the transducer with and without the media to obtain a net or gain. Since it is a differencing measurement, it will be relatively insensitive to factors, such as wear and temperature.

The preferred sensing apparatus, according to this invention, offers the following advantages: lightness in weight; ease of assembly and repair; excellent weight measurement characteristics; good stability; excellent durability; and good economy. In fact, in many of the preferred embodiments, these factors of lightness in weight, ease of assembly and repair, weight measurement characteristics, and durability are optimized to an extent that is considerably higher than heretofore achieved in prior, known media weight sensing apparatus.

The above and other features of the present invention, which will become more apparent as description proceeds, are best understood by considering the following detailed description in conjunction with the accompanying drawings, wherein like characters represent like parts throughout the several views and in which:

### BRIEF DESCRIPTION OF THE DRAWINGS

FIG. 1 is a schematic illustration of a media weight sensing apparatus, according to one embodiment of the present invention;

FIG. 2 is an electrical block diagram of the media weight sensing apparatus, according to one embodiment of the present invention;

FIG. 3 is an electrical block diagram of the media weight sensing apparatus, according to another embodiment of the present invention;

FIG. 4 is an electrical block diagram of the media weight sensing apparatus, according to a further embodiment of the present invention; and

FIG. 5 is a graphical illustration of frequency gain (in decibels) vs. paperweight (in pounds).

### DETAILED DESCRIPTION OF THE INVENTION

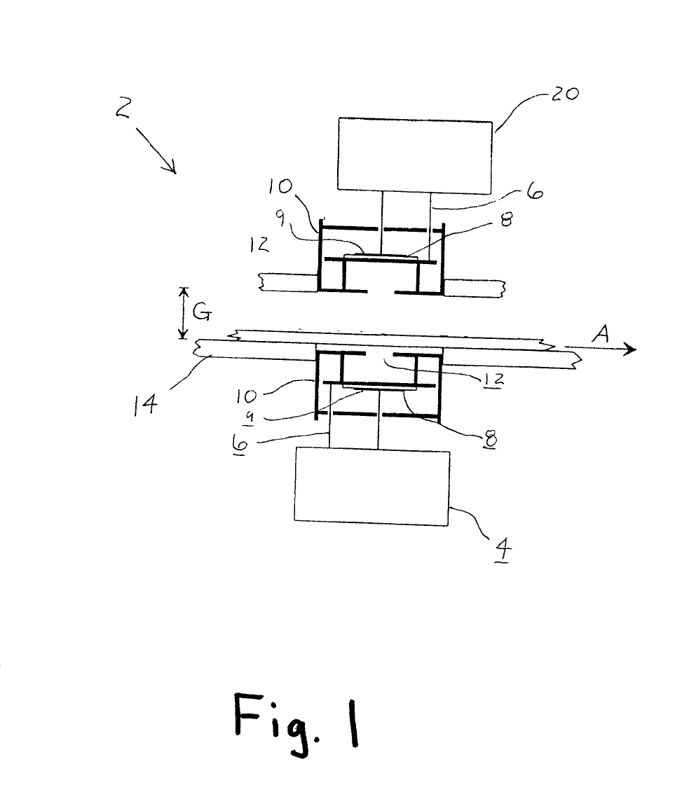

With reference first to FIG. 1, there is illustrated one preferred embodiment for use of the concepts of this invention. In particular, media weight sensing apparatus 2 is illustrated. Apparatus 2 includes, in part, drive circuit 4, two acoustic transducers consisting of conventional electrical connections 6, disks 8, piezoelectric elements 9, housings 10, and openings 12, plus media 14, and sense circuit 20. The acoustic transducers can be used to either generate or detect acoustic energy. The transducer connected to the drive circuit 4 generates acoustic energy. Some portion of that energy passes through the media 10 and is detected by the other transducer that is connected to the sense circuit 20.

Disks 8 are conventionally attached to housings 10. Disks 8 are, preferably, constructed of any suitable, metallic material with piezoelectric elements 9 attached to one side. Drive circuit 4 is conventionally attached to piezoelectric element 9 attached to one of the disk 8 and housing 10 of the lower transducer. Housings 10, preferably, are constructed of any suitable, durable material that allows drive circuit 4, disk 8, and sense circuit 20 to perform acoustic transmission measurements. Media 14 can be, but is not limited to, paper, paperboard, plastic, cloth or the like. It is to be understood that media 14 is traversed past apparatus 2 by any type of conventional traversing device (not shown) that is capable of moving media 14 past openings 12 while keeping media 14 in contact with one of the openings 12.

The acoustic transducers shown are similar and use piezoelectric elements to convert an electrical signal to acoustic energy and then acoustic energy back to an electrical signal. Transducers using electromagnetic elements rather than piezoelectric elements could be used. The two transducers need not be similar. The generating element could be piezoelectric, electromagnetic or any other suitable technology. The sensing element could be piezoelectric, electromagnetic or any other microphone technology.

As discussed above, disk 8 is attached to housing 10, thereby forming the complete transducer. Preferably, this transducer can be mounted in a printer. Preferably, media 14 is moved across the opening 12 adjacent to drive circuit 4 in the direction of arrow A. The transmission of acoustic energy between the transducers is affected by media 14. Housings 10 are separated from each other by gap G.

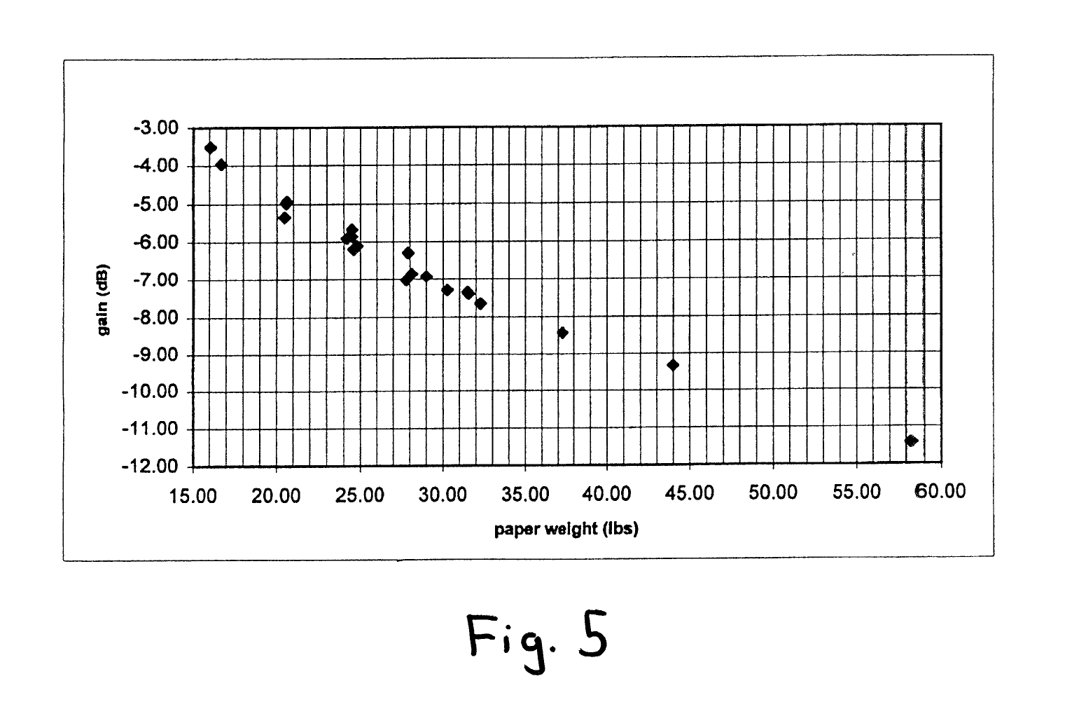

The heavier the media 14, the more acoustic transmission is reduced. Drive circuit 4 is used to produce an oscillating electrical signal of a single frequency that is converted to an acoustic tone by the generating transducer. By measuring the drop in the signal level in sense circuit 20 caused by media 14, the “weight” of media 14 can be accurately estimated, as shown in FIG. 5.

During the operation of apparatus 2, the signal level from sense circuit 20 is conventionally obtained from apparatus 2 without any media 14 being located over opening 12 adjacent to drive circuit 4. In particular, drive circuit 4 causes disk 8 generate an acoustic signal that is detected by disk 8 attached to sense circuit 20. A sample of media 14 is then placed over opening 12 by conventional techniques. A new measurement of signal level of apparatus 2 is conventionally obtained through sense circuit 20. The signal level, based upon media 14 being located over opening 12, is compared with the signal level of no media 14 being located over opening 12 to obtain a net gain, such as that shown in FIG. 5. Where gain is defined as:

gain=20*log(signal level with media/signal level without media) Eq. 1

The operator merely looks to a chart similar to the one in FIG. 5 to determine the weight of media 14. It is to be understood that charts similar to FIG. 5 can be conventionally inputted into a conventional computing device (not shown) and an automatic media weight media can be obtained from the computing device.

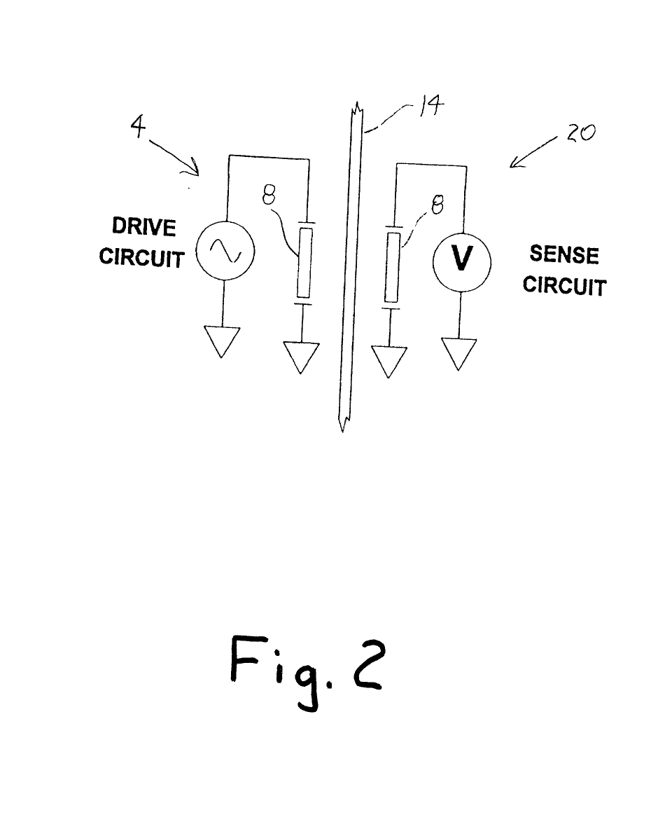

With respect to FIG. 2, there is illustrated one preferred embodiment of an electrical black diagram for use in the present invention. As can be seen, drive circuit 4 is electrically connected to disk 8. Sense circuit 20 is electrically connected to disk 8. Media 14 is traversed between the two disks 8.

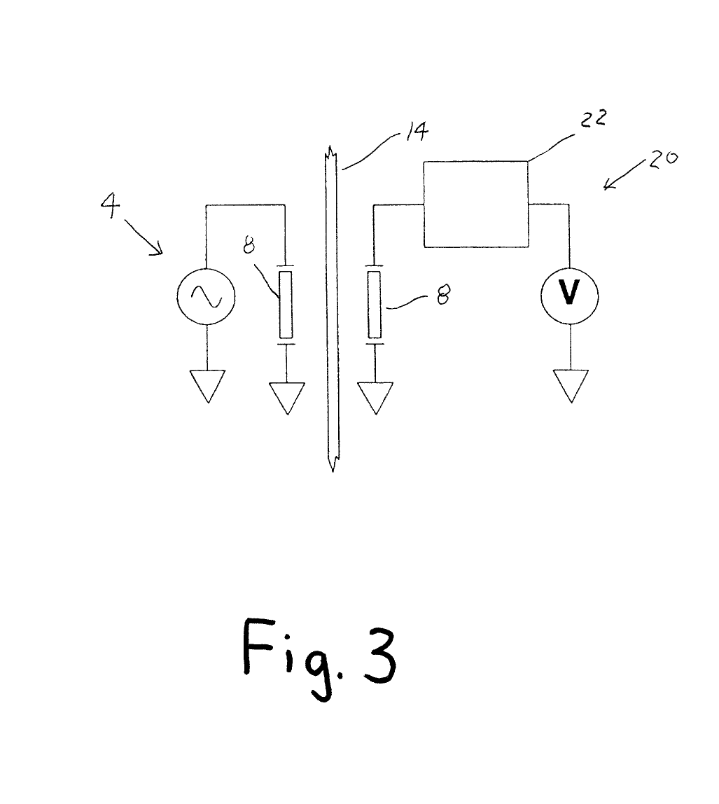

As shown in FIG. 3, there is illustrated another preferred embodiment of an electrical block diagram for use in the present invention. In particular, a conventional band pass filter circuit 22 is placed between disk 8 and sense circuit 20. Band pass filter circuit 22 is tuned to the frequency of the AC signal produced from drive circuit 4. The band pass filter filters out noise picked up by the sense transducer that would interfere with the measurement of the signal level by sense circuit 20.

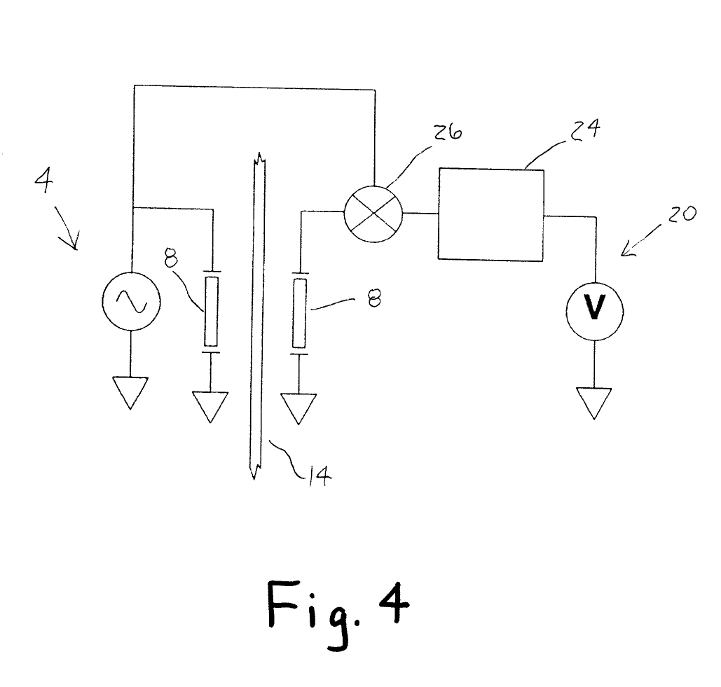

With respect to FIG. 4, there is illustrated a further preferred embodiment of an electrical block diagram for use in the present invention which further reduces the effects of any noise introduced into the system. In particular, a conventional synchronous detector 26 and conventional low pass filter circuit 24 can be electrically attached to apparatus 2. As can be seen, synchronous detector 26 is electrically connected to drive circuit 4 and sense circuit 20. Low pass filter circuit 24 is located substantially between synchronous detector 26 and sense circuit 20.

With respect to FIG. 5, the efficacy of the present invention is illustrated. In this example, the various weights of paper samples were determined based upon the net change in gain caused by the media. As can be seen in FIG. 5, one merely has to obtain the net change in gain in order to determine the weight of the paper media. For example, if a net change in gain of −|b 7.00 dB was shown by apparatus 2 on a conventional display device (not shown), one would ascertain that the paper media had a paperweight of approximately 28 pounds.

It is to be understood that apparatus 2 can be employed in a printer. For example, as media 14 is getting ready to be printed by the printer, media 14 is moved across the opening 12 adjacent to drive circuit 4 of apparatus 2 located within a housing (not shown) of the printer, as described above. In this manner, the weight of media 14 can be determined prior to printing. This weight determination will allow the printer to make conventional adjustments based upon the weight of media 14. For example, if it is determined that media 14 is heavier than the media just printed on, the printer can increase the strength of the impact, if the printer is a dot matrix printer. Also, if the printer is an electrophotographic printer, the weight of media 14 can affect the paper speed through the fuser and/or the fuser temperature.

As can be seen, the present invention measures a property that is a combination of both the thickness of media 14 and the density of media 14. As a result, the measurement should more accurately reflect the weight of media 14, than a thickness-only measurement. Also, the present invention is inherently less expensive, more efficient, and more liable than the thickness sensors. This is because disk 8 is much less expensive than inductive sensors. Also, the present invention makes its measurement without touching the paper and is not subject to wear as is a thickness sensor that must touch the moving media. Finally, the present invention makes its measurement by measuring the change of gain with and without media 14. Since it is a differencing measurement it will be relatively insensitive to factors, such as wear and temperature.

Once given the above disclosure, many other features, modifications or improvements will become apparent to the skilled artisan. Such features, modifications or improvements are, therefore, considered to be a part of this invention, the scope of which is to determined by the following claims.

What is claimed is:

1. A media weight sensing apparatus, wherein said apparatus is comprised of:
a media, whose weight is to be determined, wherein said media includes a first and a second side;
an acoustic driving transducer means located substantially adjacent to said first side of said media; and
an acoustic sensing transducer means located substantially across from said acoustic driving transducer means and substantially adjacent to said second side of said media.

2. The apparatus, as in claim 1, wherein said media is further comprised of:
paper.

3. The apparatus, as in claim 1, wherein said acoustic driving transducer means is further comprised of:
first housing;
a first disk means located substantially within said first housing; and
a drive circuit means operatively connected to said first housing and said first disk means.

4. The apparatus, as in claim 3, wherein said first housing is further comprised of:
a first opening located substantially adjacent to said media.

5. The apparatus, as in claim 3, wherein said first disk means is further comprised of:
a metallic disk.

6. The apparatus, as in claim 1, wherein said acoustic sensing transducer means is further comprised of:
a second housing;
a second disk means located substantially within said second housing; and
a sense circuit means operatively connected to said second housing and said second disk means.

7. The apparatus, as in claim 6, wherein said second housing is further comprised of:
a second opening located a predetermined distance away from said media.

8. The apparatus, as in claim 6, wherein said second disk means is further comprised of:
a metallic disk.

9. The apparatus, as in claim 1, wherein said apparatus is further comprised of:
a first filtering means.

10. The apparatus, as in claim 9, wherein said first filtering means is further comprised of:
a band pass filter circuit operatively connected to said acoustic sensing transducer means.

11. The apparatus, as in claim 1, wherein said apparatus is further comprised of:
a second filtering means.

12. The apparatus, as in claim 11, wherein said second filtering means is further comprised of:
a synchronous detector operatively connected to said acoustic driving transducer means and said acoustic sensing transducer means; and
a low pass filter circuit operatively connected to said synchronous detector and said acoustic sensing transducer means.

13. A printer, wherein said printer is capable of sensing a media weight, comprising:
a printer housing;
a media, whose weight is to be determined, wherein said media includes a first and a second side;
an acoustic driving transducer means located substantially within said printer housing and adjacent to said first side of said media; and
an acoustic sensing transducer means located substantially across from said acoustic driving transducer means and substantially adjacent to said second side of said media.

14. The printer, as in claim 13, wherein said acoustic driving transducer means is further comprised of:
a first housing;
a first disk means located substantially within said first housing; and
a drive circuit means operatively connected to said first housing and said first disk means.

15. The printer, as in claim 14, wherein said first housing is further comprised of:
a first opening located substantially adjacent to said media.

16. The printer, as in claim 14, wherein said first disk means is further comprised of:
a metallic disk.

17. The printer, as in claim 13, wherein said acoustic sensing transducer means is further comprised of:
a second housing;
a second disk means located substantially within said second housing; and
a sense circuit means operatively connected to said second housing and said second disk means.

18. The printer, as in claim 17, wherein said second housing is further comprised of:
a second opening located a predetermined distance away from said media.

19. The printer, as in claim 17, wherein said second disk means is further comprised of:
a metallic disk.

20. The printer, as in claim 13, wherein said printer is further comprised of:
a first filtering means.

21. The printer, as in claim 20, wherein said first filtering means is further comprised of:
a band pass filter circuit operatively connected to said acoustic sensing transducer means.

22. The printer, as in claim 13, wherein said printer is further comprised of:
a second filtering means.

23. The printer, as in claim 22, wherein said second filtering means is further comprised of:
a synchronous detector operatively connected to said acoustic driving transducer means and said acoustic sensing transducer means; and
a low pass filter circuit operatively connected to said synchronous detector and said acoustic sensing transducer means.
